(19) United States
(12) Patent Application Publication
(10) Pub. No.: US 2021/0264806 A1
(43) Pub. Date: Aug. 26, 2021

(54) INFORMATION PROCESSING APPARATUS AND INFORMATION PROCESSING METHOD

(71) Applicant: SONY CORPORATION, TOKYO (JP)

(72) Inventor: YUKA ARIKI, TOKYO (JP)

(21) Appl. No.: 17/250,253

(22) PCT Filed: Jun. 25, 2019
(86) PCT No.: PCT/JP2019/025115

§ 371 Date: Dec. 21, 2020

(30) Foreign Application Priority Data
Jun. 29, 2018 (JP) 2018-124101

(51) Int. Cl. G09B 9/05; G06N 20/00

(52) U.S. Cl. CPC G09B 9/05; G06N 20/00

(57) ABSTRACT

According to the present disclosure, there is provided an information processing apparatus including: an acquisition unit (102) that acquires a log related to driving on a driving simulator and acquires a transition time period for mode switching obtained corresponding to the log; a learning unit (104) that learns a relationship between the log and the transition time period; and a calculation unit (302) that calculates the transition time period corresponding to a certain driving state based on a learning result of the learning unit.

### FIELD

The present disclosure relates to an information processing apparatus and an information processing method.

### BACKGROUND

As a conventional technology, Patent Literature 1 below describes a notification to the driver about the necessity of switching from manual driving to autonomous driving as a step of receiving a data value representing switching of a second autonomous traveling vehicle from autonomous driving to manual driving and then starting a first autonomous traveling vehicle depending on the received data value.

### CITATION LIST

### Patent Literature

Patent Literature 1: JP 2017-117456 A

### SUMMARY

### Technical Problem

In a case where the driving mode is switched from one state to another state, such as switching from autonomous driving to manual driving, there might be an occurrence of discomfort in the user due to the switching. This discomfort depends on the state at a point of occurrence of the switching, and thus it is desirable to switch the mode in consideration of various states at the point of the occurrence of the switching.

However, although Patent Literature 1 describes switching between autonomous driving and manual driving, no consideration is given to a method of switching with no discomfort at the time of switching.

Therefore, it has been desired to perform switching from one state to another state while suppressing occurrence of discomfort in the user when the switching is performed.

### Solution to Problem

According to the present disclosure, an information processing apparatus is provided that includes: an acquisition unit that acquires a log related to driving on a driving simulator and acquires a transition time period for mode switching obtained corresponding to the log; a learning unit that learns a relationship between the log and the transition time period; and a calculation unit that calculates the transition time period corresponding to a certain driving state based on a learning result of the learning unit.

Moreover, according to the present disclosure, an information processing method is provided that includes: acquiring a log related to driving on a driving simulator and acquiring a transition time period for mode switching obtained corresponding to the log; learning a relationship between the log and the transition time period; and calculating the transition time period corresponding to a certain log based on a result of the learning.

### Advantageous Effects of Invention

As described above, according to the present disclosure, it is possible to perform switching while suppressing occurrence of discomfort in the user when one state is switched to another state.

Note that the above effects are not necessarily limited, and it is possible to obtain any of effects described in this specification or other effects that can be detected from this specification together with or instead of the above effects.

### BRIEF DESCRIPTION OF DRAWINGS

FIG. 1 is a schematic view illustrating a concept of applying a learning result of a game to a real car.

FIG. 2 is a schematic diagram illustrating a configuration of a system according to an embodiment of the present disclosure.

FIG. 3 is a schematic diagram illustrating a state of learning a correlation f(θ) between various logs and transition time periods in individual three exemplary environments in which a vehicle travels in a game program, which are “sandy land”, “tunnel”, and “rainy day”.

FIG. 4 is a schematic diagram illustrating a transition time period Δe between autonomous driving and manual driving when the mode is switched between autonomous driving and manual driving.

### DESCRIPTION OF EMBODIMENTS

A preferred embodiment of the present disclosure will be described in detail hereinbelow with reference to the accompanying drawings. Note that redundant descriptions will be omitted from the present specification and the drawings by assigning the same reference signs to components having substantially the same function configuration.

Note that the description will be given in the following order.

1. Summary of present disclosure
1.1. Overview
1.2. Simulator
1.3. Learning in mode switching
1.4. Significance of learning mode switching between autonomous driving and manual driving

2. System configuration example
2-1. Overall system configuration
2.2. Example of learning by learner
2.3. Example of transition time period
2.4. Approximation method in transition time period

### 1. SUMMARY OF PRESENT DISCLOSURE

1.1. Overview

The present disclosure relates to a technique of acquiring a log related to driving when driving a vehicle on a simulator, learning behavior at the time of mode switching from the acquired log, and optimally adjusting parameters at the time of mode switching. Although the following description will be given using driving of a vehicle as an example, the environment for acquiring the log is not limited to the driving of a vehicle, and thus the technology can be applied to various environments.

1.2. Simulator

In the present disclosure, a vehicle driving simulator is used to perform learning of a log obtained from the simulator. By using a simulator, it is possible to easily acquire logs corresponding to various driving states such as driving weather, road surface conditions, car type, vehicle specifications (size, weight, or the like), driving states (speed, acceleration, steering angle). On the other hand, in a case of attempting to acquire logs from a real car, it would be difficult to collect the logs corresponding to various driving states in a short time. Therefore, using a simulator makes it possible to efficiently collect various logs corresponding to driving states by a simple method.

As a more preferable method, a game program can be used as a simulator. For example, by using a commercial game program such as Gran Turismo (registered trademark) Sport (GTS), it is possible to acquire logs corresponding to various driving states. In addition, learning a large number of logs makes it possible to apply the learning result to the real car. Furthermore, by using a game program in the development process, it would be also possible to perform learning in a situation that is not assumed in a commercially available game.

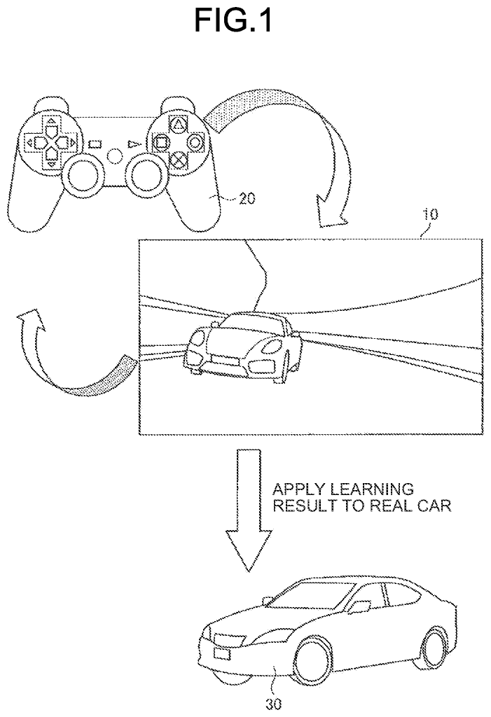

FIG. 1 is a schematic view illustrating a concept of applying a learning result of a game to a real car. At the time of learning in a game, a user operates a controller 20 while viewing a screen 10, acquires logs in various driving states, and performs learning based on the logs. The learning result is applied to a real car 30.

1.3. Learning in Mode Switching

In the present disclosure, learning is performed based on the log at the time of driving mode switching, so as to optimally adjust the parameters at the time of mode switching. Although there are various conceivable types of mode switching during driving, the present disclosure particularly focuses on mode switching between autonomous driving and manual driving. Note that the technology can be applied to other types of mode switching from a similar viewpoint.

1.4. Significance of Learning Mode Switching Between Autonomous Driving and Manual Driving

When the mode is switched between autonomous driving and manual driving, a driving subject is switched between a computer (AI) and a person. For this reason, a failure in seamless switching of various driving parameters might cause discomfort occurring at the time of switching.

In a case where electric power steering (EPS) is used, for example, an EPS motor assists steering during manual driving while it controls steering angles during autonomous driving, individually performed under different controls. In a case where autonomous driving is switched to manual driving, simply turning off the autonomous driving might cause a significant difference in a steering torque when the driver operates a steering wheel, leading to occurrence of uneasiness in the driver.

In the present disclosure, learning of the behavior of the simulator at the time of such mode switching is performed so as to achieve learning of optimum parameters at the time of mode switching. By applying the optimum parameters at the time of mode switching obtained by learning to a real car, it is possible to realize the optimal mode switching even at the time of mode switching of the real car, leading to suppression of occurrence of discomfort in the driver.

In addition, when applying the learning result obtained by the simulator to a real car, it is preferable to consider that the simulator and the real car are not completely the same and apply the learning result to the real car after performing correction, scaling, or the like, on the learning result.

### 2. SYSTEM CONFIGURATION EXAMPLE

2-1. Overall System Configuration

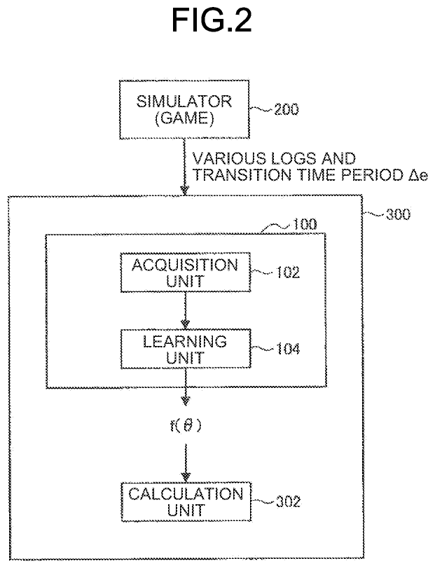

FIG. 2 is a schematic diagram illustrating a configuration of a system 1000 according to an embodiment of the present disclosure. As illustrated in FIG. 2, the system 1000 includes a learner 100 and a simulator 200. As described above, a game program can be applied as the simulator 200.

The learner 100 performs learning based on various logs obtained from the simulator 200 and a transition time period Δe for mode switching. Various logs include various types of information related to the transition time period. The various logs include various types of environmental information such as weather, wind direction, wind power, road surface states, road surface friction coefficient, corner radius, road conditions, or the like. The road surface states include information such as distinction between paved road or unpaved road, or distinction between dry or wet. The road conditions include information such as the speed limit of the road, the road type of general road or highway, the number of other surrounding vehicles, the distance from other vehicles, and the corner radius when the vehicle is traveling in a corner.

In addition, various logs include vehicle information such as operation quantities and state quantities of the vehicle. The operation quantities include a steering angle, an accelerator opening degree, a brake pedal stepping amount, a gear shift position, a light illuminance, a seat back angle, an armrest angle, and a distance between a seat and a steering wheel. The state quantities include vehicle speed, vehicle acceleration, yaw rate, vehicle center of gravity position, rotation angle, tire load, tire friction coefficient, cooling water temperature, oil temperature, vehicle specifications such as car type, vehicle weight, vehicle size such as vehicle width and length, engine displacement, motor output, vehicle body Cd value, and specifications such as tire type, tire width and size.

Furthermore, the various logs include personal information (profile information) regarding the driver. The personal information includes information such as name, age, sex, driving history, or the like.

The transition time period corresponds to a time period during which transition is performed from one mode to another mode in mode switching. The transition time period is set for each of parameters such as the accelerator opening degree, the braking operation amount, or the steering angle.

The transition time period varies depending on the environmental information and vehicle information. For example, the transition time period for the accelerator opening degree will be discussed as an example. In a case where the road surface friction coefficient is extremely low, such as when traveling on a snowy road, at the time of mode switching from autonomous driving to manual driving, it is desirable to set the transition time period longer so as to achieve smooth transition of the accelerator opening degree from autonomous driving to manual driving. This is because a short transition time period might cause unstable vehicle behavior such as vehicle slipping.

Similarly, in a case where the vehicle acceleration is high at the time of mode switching from autonomous driving to manual driving, it is desirable to set the transition time period longer so as to achieve smooth transition of the accelerator opening degree from autonomous driving to manual driving. This is because a short transition time period might cause unstable vehicle behavior such as occurrence of shock at the time of switching to manual driving.

As described above, the environmental information and vehicle information indicated by various logs are closely related to the transition time period for mode switching, leading to different transition time periods in accordance with the environmental information and vehicle information. Furthermore, the transition time period is different for each of parameters such as the accelerator opening degree, the braking operation amount, the steering angle. The simulator 200 preliminarily defines the transition time period corresponding to each of various logs, and thus the simulator 200 can be used to acquire the transition time periods corresponding to the various logs. In a case where a game program is used as the simulator 200 in particular, it is possible to acquire various type of information for various logs by using the program under development.

The learner 100 learns the relationship between various logs including environmental information and vehicle information, and the transition time period, and then obtains correlation f(θ) between the various logs and the transition time period. With the obtained correlation f(θ), the transition time period can be calculated based on the various logs. At the time of learning, for example, the training data of the output (transition time period) for the input (various logs) is referenced, so as to learn the correlation f(θ) so that the output matches the training data.

As illustrated in FIG. 2, the learner 100 includes: an acquisition unit 102 that acquires a log related to driving on the simulator 200 and a transition time period for mode switching obtained corresponding to the log; and a learning unit 104 that learns a relationship between the log and the transition time period. In addition, there is provided a calculation unit 302 that calculates a transition time period corresponding to a certain driving state based on the learning result from the learning unit 104. The calculation unit 302 may be provided in a device different from the learner 100. It is also allowable to provide an information processing apparatus 300 including the learner 100 and the calculation unit 302. The components of the learner 100, the simulator 200, and the information processing apparatus 300 illustrated in FIG. 2 may include a circuit (hardware) or a central processing unit such as a CPU and a program (software) for causing the hardware devices to function.

2.2. Example of Learning by Learner

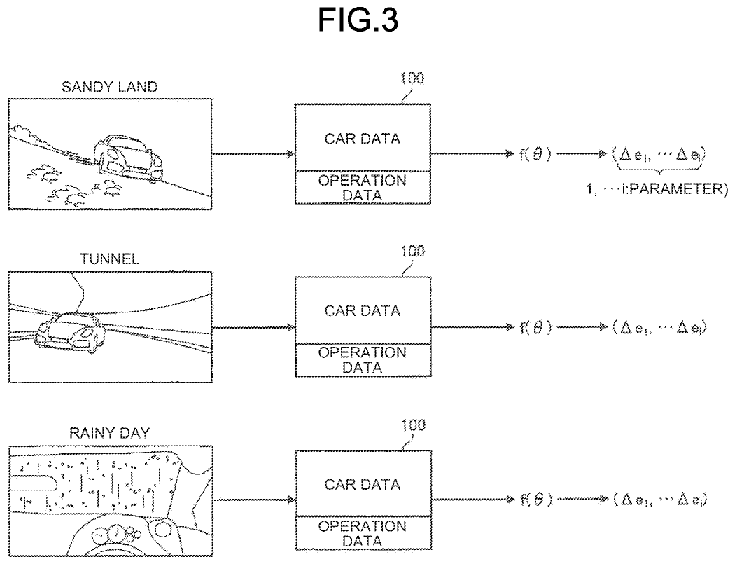

FIG. 3 is a schematic diagram illustrating a state of learning the correlation f(θ) between various logs and transition time periods in individual three exemplary environments for vehicle traveling in a game program, which are “sandy land”, “tunnel”, and “rainy day”. In the three examples having different environments, the learner 100 acquires a log of the driving state according to each of the environments and then performs learning.

Here, an example using a neural network will be described. Prediction is performed in the form of sequence-to-sequence or sequence-to-value using a recurrent neural network. The recurrent neural network is a network in which operation of a next time point is determined by an input of a previous time point and by an intermediate layer.

The correlation f(θ) can be obviously obtained by setting the previous time point to autonomous driving and setting the next time point to manual driving. The recurrent neural network has a high versatility, facilitating acquisition of this transition based on car information and operation information for various conditions. Sequence-to-sequence and sequence-to-value are methods of determining the transition range. Hereinafter, the correlation f(θ) will be described as a function f(θ) as appropriate.

The input to the learner 100 is a log indicating environmental information and vehicle information. As described above, the input includes: various environmental information such as weather, wind direction, wind power, road surface states, road surface friction coefficient, corner radius, road conditions, and vehicle information such as accelerator opening degree, brake pedal stepping amount, steering angle, vehicle speed, vehicle acceleration, yaw rate, cooling water temperature, oil temperature, vehicle specifications such as car type, vehicle weight, vehicle size, engine displacement, motor output, vehicle body Cd value, and specifications such as tire type, tire width and size.

Furthermore, transition time periods Δe1, . . . Δei at a point of switching from the autonomous driving to the manual driving are acquired from the simulator 200. The learner 100 learns a function f(θ) indicating the relationship between various logs as inputs and the transition time periods Δe1, . . . Δei.

The transition time periods Δe1, . . . Δei correspond to the transition time periods for various driving-related parameters for a point of switching from autonomous driving to manual driving. As described above, the various parameters include parameters such as the accelerator opening degree, the brake pedal stepping amount, and the steering angle.

2.3. Example of Transition Time Period

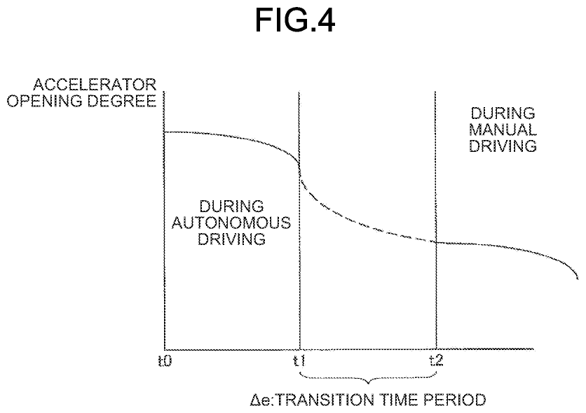

FIG. 4 is a schematic diagram illustrating the transition time period Δe between autonomous driving and manual driving when the mode is switched between autonomous driving and manual driving. As an example, FIG. 4 illustrates the transition time period Δe for the accelerator opening degree as an example.

In FIG. 4, autonomous driving is performed from time point t0 to time point t1. Then, at time point t1, the mode is switched from autonomous driving to manual driving. As described above, simply turning off the autonomous driving at time point t1 and switching to manual driving might cause a significant difference in the accelerator opening degree, leading to unstable vehicle behavior or occurrence of discomfort in the driver.

Therefore, even when the autonomous driving is turned off at time point t1, autonomous driving on the simulator 200 will not be completely switched to manual driving during the predetermined transition time period Δe, maintaining the autonomous driving state. Subsequently, the mode is completely switched at time point t2 to manual driving, and the manual driving continues after time point t2. In this manner, manual driving is enabled when the transition time period Δe has elapsed after the autonomous driving is turned off at time point t1.

The transition time period Δe varies depending on the condition at the time of mode switching, and thus takes a different value depending on the above-described environmental information and vehicle information. In the example illustrated in FIG. 4, a log and the transition time periods Δe1, . . . Δei for individual environments are acquired from the simulator 200 so as to perform the function f(θ) learning for three examples of “sandy land”, “tunnel”, and “rainy day”. Here, for example, Δe1 is the transition time period for the accelerator, Δe2 is the transition time period for the brake, and Δe3 is the transition time period for the steering angle.

After the function f(θ) is obtained by learning as described above, the transition time periods for various parameters can be obtained by assigning the driving logs into the function f(θ).

2.4. Approximation Method in Transition Time Period

Acquisition of the transition time periods for various parameters using the function f(θ) obtained by learning makes it possible to obtain the optimal transition time period for each of the parameters corresponding to the environmental information and the vehicle information. The change of each of the parameters during the transition time period can be obtained by approximating the immediately preceding characteristic.

In the example illustrated in FIG. 4, the accelerator opening degree at the transition time period between time point t1 and time point t2 (illustrated by the broken line in FIG. 4) can be obtained by approximation based on the change in the accelerator opening degree before time point t1. Furthermore, the accelerator opening degree during the transition time period can be approximated by performing learning, on the simulator 200, of the accelerator opening degree during the transition time period.

As an approximation method, it is possible to use the methods such as dynamic movement primitives (DMP), Gaussian Process (GP) and Neural Network (NN). The approximation process using these methods can be performed by the calculation unit 302 included in the information processing apparatus 300 described above, for example.

This makes it possible to achieve learning of the transition time period that can suppress uneasiness in the user and the transition characteristics in the transition time period based on the data obtained from the simulator 200.

According to the present embodiment as described above, performing learning of the transition time period corresponding to various conditions using the simulator 200 makes it possible to achieve seamless switching at the time of mode switching, leading to suppression of occurrence of discomfort in the user.

In the above description, the method of learning the transition time period of mode switching related to driving and applying it to the real car has been described, but the application of the present disclosure is not limited to driving. The present disclosure can be applied to various events in which mode switching is performed, such as cooking and fitness loads.

While the preferred embodiments of the present disclosure have been described in detail above with reference to the accompanying drawings, the technical scope of the present disclosure is not limited to or by such examples. It will be apparent to those skilled in the art of the present disclosure that various modifications and alterations can be conceived within the scope of the technical idea described in the claims and naturally fall within the technical scope of the present disclosure.

Furthermore, the effects described in this specification are merely illustrative or exemplified effects, and are not limitative. That is, the technology according to the present disclosure can accomplish other effects apparent to those skilled in the art from the description of the present specification, in addition to or instead of the effects described above.

Note that the following configurations also fall within the technical scope of the present disclosure.

(1)

An information processing apparatus comprising:

an acquisition unit that acquires a log related to driving on a driving simulator and acquires a transition time period for mode switching obtained corresponding to the log;

a learning unit that learns a relationship between the log and the transition time period; and

a calculation unit that calculates the transition time period corresponding to a certain driving state based on a learning result of the learning unit.

(2)

The information processing apparatus according to (1), wherein the transition time period is a transition time period related to mode switching of driving.

(3)

The information processing apparatus according to (2), wherein the mode switching is switching from an autonomous driving mode to a manual driving mode.

(4)

The information processing apparatus according to any one of (1) to (3), wherein the log includes personal information regarding a driver, environmental information during driving, or vehicle information during driving.

(5)

The information processing apparatus according to any one of (1) to (3), wherein a change in a parameter during the transition time period is calculated based on a change in the parameter before the transition time period.

(6)

An information processing method comprising: acquiring a log related to driving on a driving simulator and acquiring a transition time period for mode switching obtained corresponding to the log;

learning a relationship between the log and the transition time period; and

calculating the transition time period corresponding to a certain log based on a result of the learning.

### REFERENCE SIGNS LIST

100 LEARNER
102 ACQUISITION UNIT
104 LEARNING UNIT
200 SIMULATOR
300 INFORMATION PROCESSING APPARATUS
302 CALCULATION UNIT

1. An information processing apparatus comprising:
an acquisition unit that acquires a log related to driving on a driving simulator and acquires a transition time period for mode switching obtained corresponding to the log;
a learning unit that learns a relationship between the log and the transition time period; and
a calculation unit that calculates the transition time period corresponding to a certain driving state based on a learning result of the learning unit.

2. The information processing apparatus according to claim 1, wherein the transition time period is a transition time period related to mode switching of driving.

3. The information processing apparatus according to claim 2, wherein the mode switching is switching from an autonomous driving mode to a manual driving mode.

4. The information processing apparatus according to claim 1, wherein the log includes personal information regarding a driver, environmental information during driving, or vehicle information during driving.

5. The information processing apparatus according to claim 1, wherein a change in a parameter during the transition time period is calculated based on a change in the parameter before the transition time period.

6. An information processing method comprising:
acquiring a log related to driving on a driving simulator and acquiring a transition time period for mode switching obtained corresponding to the log;
learning a relationship between the log and the transition time period; and
calculating the transition time period corresponding to a certain log based on a result of the learning.
